(19) United States
(12) Patent Application Publication
(10) Pub. No.: US 2025/0021222 A1
(43) Pub. Date: Jan. 16, 2025

(54) Touch pad cell phone

(71) Applicant: James V. Filomio, JR., Kansas City, MO (US)

(72) Inventor: James V. Filomio, JR., Kansas City, MO (US)

(21) Appl. No.: 18/793,555

(22) Filed: Aug. 2, 2024

Related U.S. Application Data
(63) Continuation-in-part of application No. 17/803,721, filed on Oct. 31, 2022.

(51) Int. Cl. G06F 3/0487; G06F 3/0354

(52) U.S. Cl. CPC G06F 3/0487; G06F 3/03547

(57) ABSTRACT

The said invention is a device that utilizes all open space on electronic devices to add technology for the advancement of user's experiences. The invention adds touchpad surfaces to electronic devices, along with clicker buttons to advance gaming and electronic development. A downloaded application mates with the devices touchpads and makes using devices one handed. A viewing element cursor is controlled by the touchpad surface and positioned where a user hand position rest during use to initiate the devices software.

A electronic device with a built in Touch Sensitive Pad or Classic Touchpad, a front viewing element cursor, taskbar, and a downloadable application for updates, operations and functions. The said invention will support a power switch, clicker button(s), also a button to switch device from scrolling to cursor initiation, and a detachable, attachable touchpad housing that can be used as a separate mouse for device operations.

In one embodiment the touchpad housing is a separate unit from the viewing element section, and mates with any existing smart device for the same controls.

A Touch Sensitive Pad does not have a center clicker (mouse clicker) in or under the touch surface, in which the touchpad housing will support separate clicker buttons.

A Classic Touch Pad has a center clicker (mouse clicker) in or under the touch surface.

The said invention supports both types of touch surfaces and will be labeled, ‘touch surfaces’ for this application.

A smart device definition: A smart device is an electronic device generally connected to other devices or networks via different wireless protocols that can operate to some extent interactively and autonomously and might be heard in this invention application.

Also, the said device has internet access, capable of running downloaded applications, web browsing, wireless synchronization, wireless and telecommunications and cameras.

### BACKGROUND OF INVENTION

The said invention is designed so an electronic device can be operated one handed, or for advanced gaming and overall use. The Touch surface, cursor, taskbar and clicker button(s) initiate devices systems of said device one handed. Input (touch) to the Touch surface initiates cursor movement on the front element screen. The Touch surface along with the clicker button(s) navigate the device and initiate graphical user interface(s) operations. Position the front element cursor over a graphical user interface on the front viewing element with input to the touch surface, pressing the clicker button(s) initiates a command. Example would be, positioning cursor over video play icon, then pressing mouse clicker, the video will play.

The said invention incorporates an on-screen taskbar that allows for ‘swapping’ graphical user interface(s) for quicker use. The taskbar is a section on the viewing screen that allows the user to add or remove graphical user interface. Examples include, a volume icon, scrolling icon, photo page.

The touchpad is not limited to design.

The cursor is not limited to design.

The taskbar can be repositioned on the screen.

The clicker buttons, when house in the device and not the touch surface, are not limited to design, and not limited to one or more.

Cursor speed on front viewing element can be adjusted in device setting.

### BRIEF SUMMARY OF INVENTION

The said invention incorporates a Touch surface that is opposite of front viewing element, with input, controls movement of a cursor on the front element of the electronic device. The input (touch) to the touch surface initiates movement of the on-screen cursor on the touch screen element, controlling systems and applications of device. When cursor position is achieved, meaning, positioning the cursor over a graphical user interface, clicker button(s) are pressed to initiate that application, such as a ‘mouse click’ on a computer. Example, picture taking, opening applications.

In the design of the said invention, clicker buttons are programmed to the same measurements and code and pressed together achieve the same command as if one were pressed alone.

Advanced settings of the clicker buttons allow change in actions of the buttons, for example, pressing and holding down a clicker button with input to touch surface initiates scrolling.

Touch Sensitive Pad is not limited to one, and in some embodiments two or more Touch Sensitive Pads are used. Location of Touch Sensitive Pad is not limited to locations.

### BRIEF DESCRIPTION OF SEVERAL VIEWS OF THE DRAWINGS

FIG. 1 of the drawings illustrates an example electronic device (a smart phone) for this instance. FIG. 1. The touch screen front view of the said invention. The on-screen cursor (A) moves the entire surface of front mounted display element. (X), clicker button number 1 and (Z), clicker button number 2. (J) Illustrates an on-screen Taskbar, where selected graphical user interface(s) are positioned for easy access. (A) on-screen cursor. (B) is the devices power switch. (P) Illustrates the button that toggles the touch surface input actions from cursor control to page scrolling. (R) is the viewing element housing. (T) illustrates the touch sensitive pad or touch surface.

FIG. 2 Illustrates a rear view of an example device, (T) Illustrates touch surface. (X), (Z) illustrate clicker buttons shown from the rear view.

FIG. 3. Illustrates hand position against the (T) touch surface.

FIG. 3 Illustrates a rear view of the viewing element (R) with the touchpad/clicker button housing (Y) detached.

FIG. 4 Illustrates an example electronic device with multiple touch surfaces (T).

FIG. 5, illustrates hand position on a smart device in relation to touch surface (T).

### DETAILED DESCRIPTION OF THE INVENTION

The invention will now be described in detail with reference to a few specific details of the device, systems, patterns, but in no way should be intended to limit the disclosure to the described embodiments.

In electronics the definition of ‘Circuit’ or ‘Circuited’ follows as, ‘A configuration of electrically or electromagnetically connected components of devices’.

The schematic of the components of the invention are circuited to perform further actions below.

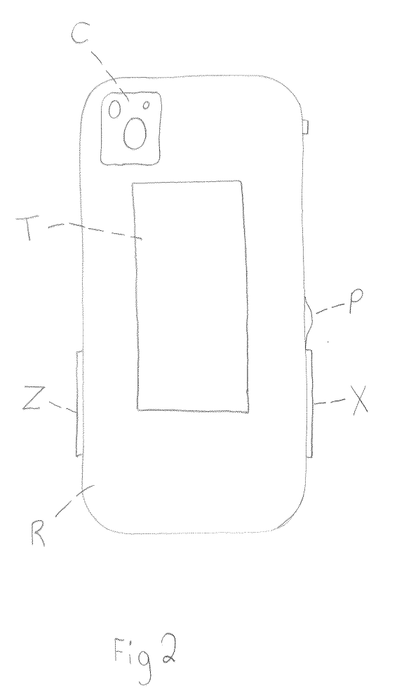

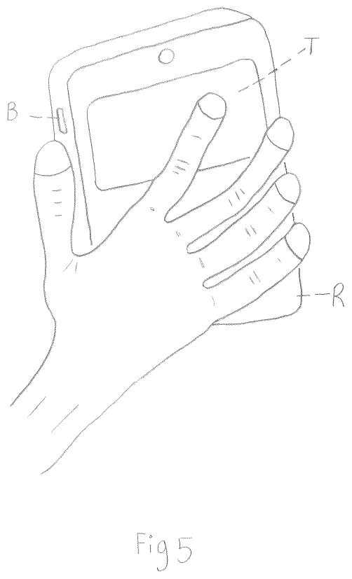

FIG. 2, Touch surface (T) is located on opposite side of display element on an electronic device and is operated by input from (example, index finger(s)) movements as shown in FIG. 5. Touch surface (T) is not limited to size, shape or design, and not limited to two or more touch surfaces.

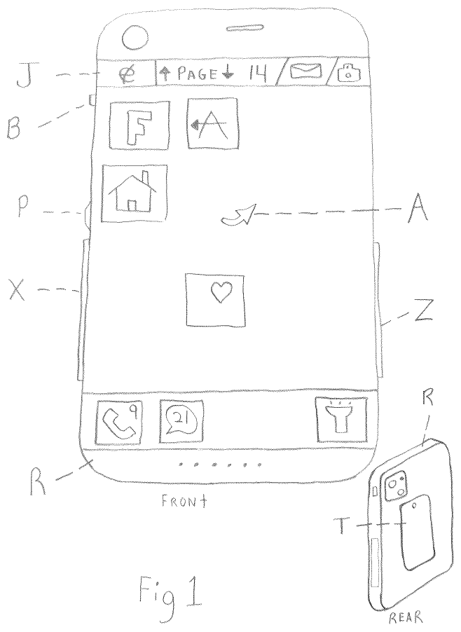

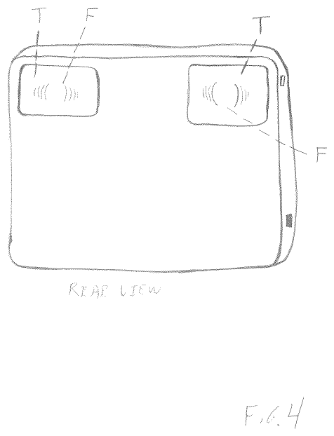

Touch surface (T) when manipulated by input, example users index finger, will move the cursor (A) FIG. 1, over front display element, and when cursor (A) is positioned over a graphical user interface pressing ‘clicker buttons’ (X) and or (Z), initiating the application operation. One embodiment where the clicker button is located in the touch surface, example in FIG. 4, illustrates center clicker buttons on touch surface (T), that clicker button would be pressed to initiate the applications operations. The clicker buttons in FIG. 4 are labeled (F) and are not visible.

FIG. 1. (P) Illustrates the button that allows the user to switch the action of the input to the touch surface (T). Example, using the touch surface (T) to control on-screen cursor (A) movement. To toggle touch surface (T) action to scrolling on-screen pages, pressing the (P) on FIG. 1, converts input on touch surface (T) to viewing element scrolling. Pressing (P) FIG. 1, again, will toggle touch surface (T) input into (A) cursor movement. Example, on one embodiment where two side mounted clicker buttons (X), (Z) are present, moving (A) cursor onto (J) taskbar scrolling graphical user interface page arrow, (FIG. 1,) Taskbar (J), pressing clicker button (X) and/or (Z) while cursor (A) is over graphical user interface for down page arrow tab, will scroll on-screen pages in that direction. Furthermore, pressing and holding down clicker buttons (X) and/or (Z) while input to touch surface (T), will for example, highlight text.

Cursor (A) disappears from front viewing screen after an adjustable time length in settings after not having input to touch surface. Cursor (A) reappears with input to touch surface, (T). The device comes with a factory setting of length predetermined.

In one embodiment, task bar (J) can be ‘removed’ off display screen. Taskbar (J) location and size is adjusted on viewing element. In settings the taskbar (J) can be programmed on or off front viewing element, time sensitive on/off, and or controlled with cursor movement, further, different graphical user interfaces applications can be added or removed from taskbar (J), example, scroll tab, volume tab.

The design and location of Touch surface (T), allows device to be held and operated in any angle, (vertical or horizontal), so when the device is turned from vertical to horizontal, taskbar (J) will adjust with the repositioning to remaining vertical.

In one embodiment the Touch Sensitive Pad (T) is a multi-touch surface.

The said invention is not limited to physical switches and or accessories, buttons or sensors or on-screen application tabs or graphical user interfaces, examples, volume buttons, camera's speakers, receivers.

Input to touch surface (T) controls cursor (A) movement on front viewing screen by input movement on Touch surface (T), the movement and location of cursor (A) on front display element is determined by the input, movement and location on Touch Sensitive Pad (T).

Input to touch surface (T), for example, index finger of user moves on-screen cursor (A) in accordance with movement against Touch surface.

Example of use, operator slides index finger across the touch surface (T) from (bottom to top) positioning front on-screen cursor (A) over graphical user interface (example volume tab) in taskbar (J).

Example of use, operator slides index finger across touch surface (T) from (bottom to top), positioning front on-screen cursor (A) over graphical user interface (volume UP tab) in task bar (J), pressing clicker button (X) will initiate device's volume to rise.

Example of use, operator slides index finger across Touch surface (T) from (bottom to top), positioning front on-screen cursor (A) over graphical user interface (volume UP tab) in task bar (J), pressing clicker button (Z) will initiate device's volume to rise.

Example of use, operator slides index finger across touch surface (T) from (bottom to top), positioning front on-screen cursor (A) over graphical user interface (volume UP tab) in task bar (J), pressing both clicker buttons (X) and (Z) will perform the device's volume to rise.

Example of use, operator slides index finger across touch surface (T) from (bottom to top), positioning front on-screen cursor (A) to start of word document (job resume) file, pressing and holding down one or both clicker buttons (X), (Z) while sliding index finger down the surface of touch surface (T) will highlight the attended area.

Example of use, the highlighted area of line (job resume) can be (copied) by pressing one or both clicker buttons (X), (Z) after operator slides (index finger) across touch surface (T) to position on-screen cursor over highlighted area, by pressing clicker (X) FIG. 1 for example will display device's task bar for (copy, paste, cut), input to touch surface relocates front on-screen cursor (A) over (COPY) tab, pressing clicker button (X) for example will copy said text.

Example of use, operator slides index finger across touch surface (T) from (left to right), positioning front on-screen cursor (A) over graphical user interface, example ‘PURCHASE’ tab on an ‘online store’, pressing one or both clicker buttons (X), (Z) with initiate the ‘purchase’.

Example of use, operator slides index finger across touch surface (T) from (right to left), positioning front on-screen cursor (A) over graphical user interface (search bar), pressing one or both (Z) (X) clicker buttons will add a ‘text symbol’ (blinking blue line) to the search bar for starting text or type.

Input to the (T) touch surface and input to the front touch screen can be used simultaneously.

Example of use, operator slides (index finger) across (T) touch surface from left top, diagonally downward stopping on-screen cursor (A) at graphical user interface banking application icon, pressing one or both of the (clicker buttons) initiates banking application to active (open).

Example of use, the on-screen cursor (A) can be removed from front viewing screen in the setting or in the inventions downloaded application. Input to the touch surface can also be adjusted in the device's settings or our application.

The cursor/scroll button (P) is not limited to design.

The cursor/scroll button (P) is not limited to type of button, (press button, toggle, soft key or sensor.

Powering off device main power switch will turn off Touch surface circuit.

Task bar (J) can be moved to any location on the front screen element by, positioning the onscreen cursor (A) over the taskbar (J), pressing and holding either or both clicker buttons (X), (Z), input to touch surface will move the taskbar (J) in the direction of input to touch surface. To release the taskbar (J) to a desired position, release the pressed clicker button(s), (X), (Z).

Pressing either clicker button (X), (Z) may produce a sound or vibration. The sound or vibration of the pressing of a clicker button could be controlled in settings.

Clicker button(s) (X), (Z), cursor (A) and touch surface (T) initiate graphical user interface feature of the device that the front touch screen and input (touch) could accomplish.

One embodiment for scrolling page down, positioning cursor (A) over task bar (J) and over symbol for scroll down graphical user interface in taskbar (J). When cursor (A) is positioned over down symbol, pressing clicker button (X), (Z) and page will begin to move, to stop page movement release pressed clicker button (X), (Z).

Example of use, the speed of the cursor on viewing screen is adjustable to preference. Example of one embodiment, a slow sliding input across touch surface (T) from left to right drags the cursor (A) from left to right on viewing screen at the same pace of input on touch pad.

Example of use, in one embodiment, a slow sliding input across touch surface from left to right drags the cursor (A) across viewing screen at a rate of 2× as fast as input across touch surface.

Cursor speed preference is adjusted in device settings on a sliding scale.

Example of use, user presses cursor/scroll button (P), initiating touch surface input to swipe pages on front viewing element. Use presser cursor/scroll button (P) again, touch surface (T) input initiates now control cursor (A) movement on front viewing element.

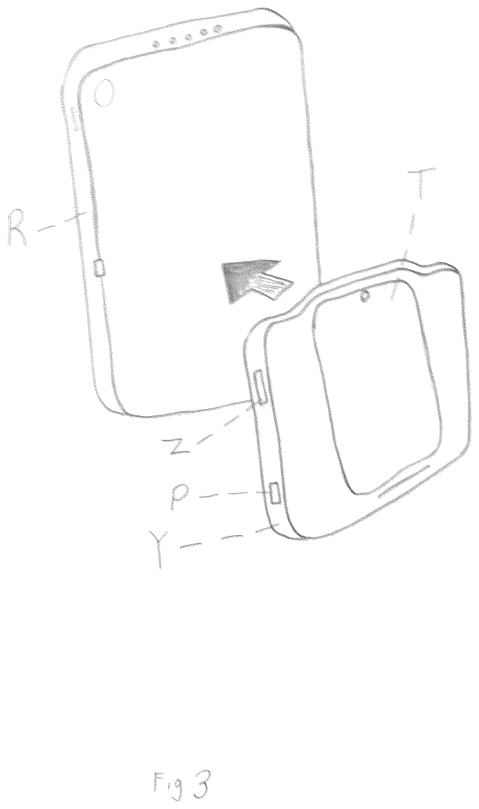

Example of use, FIG. 3 illustrates the touch sensitive pad/clicker button housing (Y) detached from viewing element housing (R). With the touch sensitive pad/clicker button housing (Y) detached, the housing (Y) is wirelessly connected to (R) housing. Thus, making housing (Y) a separate mouse like device that can operate viewing element housing (R) and on-screen cursor (A) functions and device system interfaces and operations, as if it were still attached to (R), with the same actions as in above examples in this patent.

The touch sensitive pad/clicker button housing (Y) has its own battery.

The said device viewing element housing (R) and touch sensitive pad/clicker button housing (Y) mate together and are separated for use in example, propping viewing element housing (R) upward and controlling (R) operating system, graphical user interfaces, software, hardware wirelessly by housing (Y) components and input.

The said device housing (Y) when detached from (R) viewing housing, (Y) acts as a wireless computer mouse against (R) and control cursor (A). The clicker buttons (X) (Z) function wirelessly, and initiate cursor (A) graphical user interfaces.

The said device acts in same operation manner if (Y) is attached or detached from (R) housing.

One embodiment of the invention, the device touch sensitive pad, clicker button(s), cursor/scroll housing removes from viewing element housing to be used as a wireless mouse to the viewing element housing.

One embodiment of the invention, the device touch sensitive pad, clicker button(s), cursor/scroll housing does not remove from viewing element housing.

The said device in one embodiment had two charging ports, one to power the touch pad/clicker button, one to power the viewing element software batteries.

In one embodiment, there is only one charging port.

In one embodiment, input to touch sensitive pad will turn on device.

The touch pad, clicker button housing, is removeable from viewing element housing, and reattached via sliding into the viewing element housing and snapping-in by the means of design, but is not limited by design for mating.

In one embodiment, the touch pad, clicker button housing is a separate unit that mates with any existing device for the same results.

In one embodiment, the touch pad, clicker button housing is a separate unit that mates with any existing device, and is not limited to design or mating capabilities.

In one embodiment, the touch pad, clicker button housing is a separate unit that mates with any existing device, and is interchangeable with any device.

What is claimed is:

1. A electronic device comprising:
Touch screen display viewing element; and
display element cursor;
taskbar;
cursor/scrolling button;
clicker button(s);
power switch;
wireless communication, telecommunication, internet access, capabilities of running downloaded applications, web browsing, wireless synchronization, camera; and
batteries;
viewing element housing;
touch sensitive pad, clicker button(s), cursor/scroll button housing; and
software designed to manage device; and
controllers; and
processors; and
semiconductors; and
Applications; and
touch surface in multiple embodiments comprising:
A. In one embodiment the Touch Sensitive Pad does not have a center clicker button in or under the touch surface, in which the housing will support separate clicker buttons; and
B. In one embodiment the Touch Sensitive Pad has a center clicker button in or under the touch surface; and
C. In one embodiment the Touch Sensitive Pad has a center clicker button and supports clicker buttons in the housing; and
Touch Sensitive Pad is not limited to one, and in some embodiments may have two or more;
Touch Sensitive Pad(s) is not limited to location or locations;
The touchpad, cursor/scroll button and clicker buttons are in a separate housing from viewing element housing, they are connected wirelessly. The touchpad housing can be removed from viewing element housing to be used wirelessly as a mouse; and
input to touch surface is touch from example, the users index finger; and
in response to input on touch surface, controlled movement of display cursor initiates in the same direction as input to touch surface;
positioning cursor over a graphical user interface, pressing one or both ‘clicker buttons’ initiates graphical user interface application operation; and
holding down clicker button(s), with input to touch surface, initiates device features; examples; highlighting or sliding scales graphical user interface icons such as volume; and
positioned cursor over graphical user interface while holding down clicker button(s), then moving input on the touch sensitive pad initiates device features such as sliding adjustments, example; system setting brightness and ringer volume.

2. A method of claim 1 wherein input initiates devices systems, functions, commands, applications, operators' applications;
input to touch surface initiate display viewing element cursor movement;
cursor is positioned over a graphical user interface; and
clicker button(s), when pressed initiates command for selected graphical user interface operation; and
holding clicker button(s) down, with touch surface movement input initiates device systems graphical user interface for such command or operation;
cursor/scroll button initiates device touch surface input to toggle from cursor control movement on viewing element to page scrolling or swiping on viewing element.

3. The method of claim 1 wherein actions comprising initiating devices operating system, applications, hardware system and software systems;
input to touch surface initiate element cursor movement on viewing element; and
cursor is positioned over a selected graphical user interface; and
clicker button(s), when pressed or held down initiates command for selected graphical user interface; and
pressing cursor/scroll button initiates device touch surface input to toggle from cursor control on viewing element, to page or site scrolling or swiping on viewing element.

4. The method of claim 1 wherein one embodiment the cursor/scroll button is not limited to act as a soft key button, the definition of a soft key button is as follows, a soft key on a computer is a button that can be flexibly programmed to invoke various functions, rather than being tied to a single fixed function.

5. The method of claim 1 wherein the on-screen taskbar to be repositioned on the front screen element;
In one embodiment, the taskbar is moved about the viewing element by user input over the taskbar on front element and moved to different location by input movement on front viewing element.

6. The method of claim 1 wherein one embodiment the act of taskbar displaying operator selected graphical user Interface, housing display element cursor when not in use and cursor is controlled time sensitive to return to task bar after set time of inactivity, wherein when cursor is stowed in taskbar.

7. The method of claim 1 wherein the act of removing taskbar from front display element;
in device application settings, user could select to remove taskbar from front display element with option setting; and
in device application settings, user could select to install taskbar on front display element with option setting.

8. The method of claim 1 wherein the act of removing cursor from taskbar;
pressing clicker button(s) initiates removing cursor from taskbar and onto viewing element.

9. The method of claim 1 wherein the act of moving the cursor back onto the taskbar from the front touch screen display element:
input to touch surface moves cursor to taskbar; and
when cursor is positioned in taskbar, pressing clicker button(s) initiates cursor mating with taskbar.

10. The method of claim 1 wherein the act of rotation of device initiates taskbar and cursor to rotate accordingly;
rotating device from vertical to horizontal, initiates taskbar to adjust to a horizontal position, allowing user to see taskbar graphical user interface in an upright reading position.

11. The method of claim 1 wherein the act of rotation of device initiates user input to touch surface to adjust;
rotating device between vertical and horizontal positions initiates input to touch surface to react with cursor in the same manner; and
further definition to claim 11, input in any direction on touch surface moves cursor in the same direction if device is held vertically or horizontally.

12. The device of claim 1, further comprising;
a housing that surrounds the electronics of device; and
a separate housing for the touchpad, clicker button(s) and cursor/scroll button, that is detachable and re-attachable to the viewing element housing of the electronic device, the touchpad/clicker button(s) and cursor/scroll button housing is connected wirelessly to the device operating systems that supports functions, cursor movement, graphical user interfaces operations, system operations and device actions and functions; and
display element cursor; and
taskbar; and
clicker button(s); and
a touch surface in multiple embodiments comprising: and
in one embodiment the Touch Sensitive Pad does not have a center clicker button in or under the touch surface, in which the housing will support separate clicker buttons; and
in one embodiment the Touch Sensitive Pad has a center clicker button on or under the touch surface; and
in one embodiment the Touch Sensitive Pad has a center clicker button and separate clicker button(s) in the touchpad housing; and
battery or batteries, power switches, buttons and circuitry for device; and
battery or batteries, power switches, buttons and circuitry for touchpad/clicker button(s) housing; and
cursor/scroll button; and
memory; and
one or more processors; operational settings menu;
one or more controllers; and
charging port(s).

13. The device of claim 1 wherein the viewing element is touch screen.

14. The device of claim 1 wherein device initiates graphical user interface(s) operations or actions.

15. The device of claim 1 wherein taskbar graphical user interface or applications icons can be removed and placed but come factory set with volume, page scrolling icons.

16. The device of claim 1, in one embodiment, mouse clicker buttons are located on the sides of the touchpad/clicker button(s) and cursor/scroll button housings, in device application settings, clicker buttons functions can be adjusted;
user navigates to device application settings; and
scrolls to clicker button functions; and
clicking the icon for button functions, displaying buttons actions and modes; and
example, left clicker button can be turned off by input to left clicker button icon on/off icon; and
example, under clicker button settings, button actions initiation tone or vibration mode can be adjusted.

17. The device of claim 1 wherein clicker button(s) may be held down to initiate graphical user interface compatible operations.

18. The device of claim 1 wherein one embodiment, pressing clicker button(s) initiates sound or vibration.

19. The device of claim 1 wherein speed of on-screen cursor is adjustable against the speed of the input on touch surface.

20. The device of claim 1, wherein the touchpad/clicker button, cursor/scroll button housing can be removed from device housing and used as a wireless mouse, against the viewing element systems, attachment and removal to or from viewing element is not limited by design.
